(19) United States
(12) Patent Application Publication
(10) Pub. No.: US 2020/0123370 A1
(43) Pub. Date: Apr. 23, 2020

(54) COMPOSITION AND METHOD FOR PRODUCING COMPOSITION

(71) Applicants: DAIKIN AMERICA, INC., Orangeburg, NY (US); DAIKIN INDUSTRIES, LTD., Osaka-Shi, Osaka (JP)

(72) Inventors: Cheng QU, Decatur, AL (US); Arthur MARTIN, Decatur, AL (US)

(73) Assignees: DAIKIN AMERICA, INC., Orangeburg, NY (US); DAIKIN INDUSTRIES, LTD., Osaka-Shi, Osaka (JP)

(21) Appl. No.: 16/604,321

(22) PCT Filed: May 18, 2018
(86) PCT No.: PCT/JP2018/019399

§ 371 Date: Oct. 10, 2019

Related U.S. Application Data
(60) Provisional application No. 62/508,551, filed on May 19, 2017.

(51) Int. Cl. C08L 27/18; C08K 3/34; C08K 3/08; C08K 5/01; B29C 48/00

(52) U.S. Cl. CPC C08L 27/18; C08K 3/34; C08K 3/08; C08K 5/01; B29C 48/0013; C08K 2003/0806; C08L 2203/30; C08K 2003/0893; C08K 2201/005; C08L 2201/00; C08L 2203/02; C08L 2203/16; C08L 2203/18; C08K 2003/085

(57) ABSTRACT

A composition containing polytetrafluoroethylene and zeolite supporting a metal, and a method for producing the composition. Also disclosed is a composition containing an organic solvent and zeolite supporting a metal, and a molded article made from the compositions.

### TECHNICAL FIELD

The disclosure relates to compositions and methods for producing a composition.

BACKGROUND ART

Fluororesins have excellent characteristics such as thermal resistance, chemical resistance, solvent resistance, and insulation properties. For this reason, fluororesins are molded into various products such as tubes, pipes, and filaments by, for example, melt extrusion molding, and such products have been made commercially available.

In particular, polytetrafluoroethylene (“PTFE”), including fine powders and molding powders, is applied in the medical field (such as for tubing or as catheter for fluid transfer, film for packaging, tape for diagnostic equipment, etc.), for clothing and footwear (such as fabric membrane in clothes, patches in shoes, etc.), for industrial applications (such as air and water filtration), and in the food industry (such as linings in tanks and chutes, and as packaging films, pouches, and bottles), in the form, for example, of tubing, porous membrane, tape, and film. However, microbes such as mold, mildew, bacteria, and fungi can contaminate these articles when in use, which will restrict the applications of PTFE for these purposes. Therefore, it will be of utility to develop PTFE compositions having an antimicrobial capability. Typically, but not necessarily, PTFE fine powder particles are extremely small, measuring approximately 0.2-0.4 μm in size. In appearance a large number of these tiny particles aggregate, forming secondary particles of approximately 500 μm in size. PTFE molding powder is a granular powder with an average particle size ranging from tens to hundreds of micrometers.

Patent Literature 1 discloses production of a titanium oxide-containing PTFE powder by mixing an aqueous dispersion containing emulsion-polymerized PTFE particles and an aqueous dispersion containing titanium oxide, and then co-agglomerating the particles and drying the co-agglomerated particles.

Patent Literature 2 discloses a medical device including a sleeve containing expanded PTFE and a bioactive agent.

Patent Literature 3 discloses production of a fluororesin film by sufficiently stirring components such as 85 parts of a PTFE aqueous dispersion with a solid content of 60 wt %, 15 parts of an organic solvent-based regulating liquid, and 2.53 parts of antimicrobial zeolite (4 wt % in the solid content of coating) to prepare a fluorine resin composition, spraying the composition, and sintering the sprayed composition at 427° C. for five minutes.

Patent Literature 4 discloses production of antimicrobial silver zeolite with a fluororesin coating by dispersing and suspending 500 g of zeolite supporting silver ions in 1 L of a 0.8% aqueous solution of a sodium polyacrylate dispersant (solid content: 45 wt %), adding a fluororesin coating (solid content: 65 wt %) thereto, stirring and filtering the mixture, and then heat-drying the residue at 120° C.

Although not intended for the antimicrobial uses, Patent Literature 5 discloses production of a reaction layer-coated gas feed layer sheet of a gas diffusion electrode from a reaction layer dispersion obtained by dispersing 50 parts of silver fine particles in 150 parts of petroleum naphtha using an ultrasonic disperser, adding 10 parts of PTFE fine powder, and mixing the components by ultrasonic dispersion.

Patent Literature 6, the content of which is hereby incorporated by reference, discloses antimicrobial films. Agion® can be used as an antimicrobial agent in the film.

Patent Literature 7, which is assigned on its face to 3M Innovative Properties Company and the content of which is hereby incorporated by reference, discloses a multi-layer film with Agion® as an antimicrobial agent in the antimicrobial layer.

Patent Literature 8, which is assigned on its face to Zeus Industrial Products and the content of which is hereby incorporated by reference, discloses a method of preparing antimicrobial-containing polymeric products. The method involves electrospinning a dispersion containing a dispersible polymer, a fiberizing polymer, and one or more antimicrobial agents.

Patent Literature 9, the content of which is hereby incorporated by reference, discloses an antimicrobial strap. Agion® can be used as an antimicrobial agent in the strap.

Patent Literature 10, which is assigned on its face to 3M Innovative Properties Company and the content of which is hereby incorporated by reference, discloses a microstructured antimicrobial film with Agion® as an antimicrobial agent.

Patent Literature 11, which is assigned on its face to Brennen Medical, Inc. and the content of which is hereby incorporated by reference, discloses a composition for medical applications that contains an antimicrobially effective and immune-stimulating amount of a combination of a β-glucan component and a silver-containing component.

Patent Literatures 12 and 13, which are assigned on their faces to 3M Innovative Properties Company and the contents of which are hereby incorporated by reference, disclose a film-forming composition that can form a water-insoluble, biocidal antimicrobial film. Agion® can be used as an antimicrobial agent in the composition.

Patent Literature 14, which is assigned on its face to ICET, Inc. and the content of which is hereby incorporated by reference, discloses an antimicrobial and chemical deactivating composition for use in a liquid medium or for incorporation into a coating, structural plastic materials, thin microporous membranes, textiles, and sponges.

Patent Literature 15, which is assigned on its face to Aglon Technologies Inc. and the content of which is hereby incorporated by reference, discloses antimicrobial catheters and other medical devices having controlled release of an antimicrobial metal or metal ion. Agion® can be used as an antimicrobial agent in the devices.

Patent Literature 16, the content of which is hereby incorporated by reference, discloses antimicrobial additives that are capable of releasing antimicrobial metal ions.

Patent Literature 17, which is assigned on its face to Wilson-Cook Medical Inc. and the content of which is hereby incorporated by reference, discloses a sleeve for use in medical devices that includes a biodeposition-reducing bioactive agent, such as an antibiotic or antimicrobial agent.

Patent Literature 18, the content of which is hereby incorporated by reference, discloses color stable antimicrobial coatings and coating systems comprising a silver ion-exchange type antimicrobial agent, including Agion®.

Patent Literature 19, which is assigned on its face to AK Steel Corporation and the content of which is hereby incorporated by reference, discloses metallic sheets coated with Agion® as an antimicrobial agent.

Patent Literature 20, which is assigned on its face to The Trustees Of Columbia University in the city of New York and the content of which is hereby incorporated by reference, discloses polymeric medical articles containing combinations of triclosan and silver-containing compounds. Such medical articles having suitable antimicrobial properties are stated to offer the advantage of preventing or inhibiting infection.

Patent Literature 21, which is assigned on its face to E.I. du Pont de Nemours and Company and the content of which is hereby incorporated by reference, discloses a solid surface material with an antimicrobial agent in a thermoset and/or thermoplastic resin matrix in which the antimicrobial agent contains a chitosan-metal complex.

Patent Literature 22, which lists AGION Technologies, LLC as the correspondence address on its face and the content of which is hereby incorporated by reference, discloses antibiotic silver zeolite as an antimicrobial agent used in a food tray.

Patent Literatures 23-25, which are assigned on their faces to The Trustees of Columbia University in the city of New York and the contents of which are hereby incorporated by reference, disclose infection-resistant materials, and methods of preparing those materials, that are suitable for use within the interior of a human or animal body in such forms as vascular grafts prostheses, or other implanted devices. The material is rendered infection-resistant by incorporating antimicrobial agents and other antimicrobial or antibacterial agents.

Patent Literature 26, which lists AGION TECHNOLOGIES, LLC as the applicant on its face and the content of which is hereby incorporated by reference, discloses a dental appliance with antibiotic silver zeolite as an antimicrobial agent.

### CITATION LIST

### Patent Literature

[PTL 1]

[PTL 2]

US 2008/0086214 A

[PTL 3]

JP H06-287504 A

[PTL 4]

JP H10-45410 A

[PTL 5]

U.S. Pat. No. 6,630,081 B

[PTL 6]

US 2016/0150776 A1

[PTL 7]

U.S. Pat. No. 9,247,736 B2

[PTL 8]

U.S. Pat. No. 8,685,424 B2

[PTL 9]

US 2013/0045265 A1

[PTL 10]

U.S. Pat. No. 8,318,282 B2

[PTL 11]

U.S. Pat. No. 8,231,894 B2

[PTL 12]

U.S. Pat. No. 8,124,169 B2

[PTL 13]

US 2012/0045498 A1

[PTL 14]

U.S. Pat. No. 7,445,799 B1

[PTL 15]

U.S. Pat. No. 7,354,605 B2

[PTL 16]

US 2008/0156232 A1

[PTL 17]

US 2008/0086214 A1

[PTL 18]

US 2006/0156948 A1

[PTL 19]

U.S. Pat. No. 6,929,705 B2

[PTL 20]

U.S. Pat. No. 6,843,784 B2

[PTL 21]

US 2003/0152632 A1

[PTL 22]

US 2002/0012760 A1

[PTL 23]

U.S. Pat. No. 4,612,337

[PTL 24]

U.S. Pat. No. 4,581,028

[PTL 25]

U.S. Pat. No. 4,563,485

[PTL 26]

WO 2001/037789 A1

### SUMMARY OF INVENTION

### Technical Problem

The disclosure aims to provide a composition having excellent antimicrobial performance.

### Solution to Problem

The disclosure relates to a composition comprising:
polytetrafluoroethylene; and
zeolite supporting a metal.

The polytetrafluoroethylene is preferably in the form of particles having an average particle size of 100 to 1000 μm.

The zeolite is preferably present in a proportion of 0.001 mass % or more and 5 mass % or less relative to the total amount of the polytetrafluoroethylene and the zeolite.

The composition preferably further comprises an organic solvent.

The disclosure also relates to a composition comprising:
an organic solvent; and
zeolite supporting a metal.

The organic solvent is preferably an extrusion aid for polytetrafluoroethylene.

The organic solvent is preferably a hydrocarbon solvent.

The metal is preferably at least one selected from the group consisting of copper, zinc, and silver.

The zeolite is preferably in the form of particles having an average particle size of smaller than 10 μm.

The zeolite is preferably substantially free from particles having a particle size of 10 μm or greater.

The disclosure also relates to a method for producing a composition comprising the steps of:

(1) mixing an extrusion aid, zeolite supporting a metal, and polytetrafluoroethylene to prepare a mixture (1);

(2) extruding the mixture (1) to prepare a mixture (2); and

(3) removing the extrusion aid from the mixture (2) to provide a composition containing the polytetrafluoroethylene and the zeolite supporting a metal.

The step (1) preferably includes the steps of: (1-1) mixing the extrusion aid and the zeolite supporting a metal to prepare a mixture (1-1); and

(1-2) mixing the mixture (1-1) and the polytetrafluoroethylene to prepare the mixture (1).

The mixing in the step (1-1) is preferably performed under ultrasonic irradiation.

The disclosure also relates to a molded article comprising the composition.

The molded article is preferably in the form of a tube.

The molded article is also preferably in the form of a film.

The molded article is also preferably in the form of a porous film.

### Advantageous Effects of Invention

The disclosure provides a composition having excellent antimicrobial performance.

### BRIEF DESCRIPTION OF DRAWINGS

FIG. 1 is a photograph of the compression-molded disk samples of the PTFE compositions that were tested in Example 1.

FIG. 2 is a photograph of the extruded strands (on the left) and the final tape samples (on the right) of (a) unsintered Polyflon™ F-107 with no Agion®, (b) unsintered Polyflon™ F-107/0.01% Agion®, (c) unsintered Polyflon™ F-107/0.1% Agion®, and (d) unsintered Polyflon™ F-107/0.5% Agion® obtained in Example 2.

FIG. 3 is a photograph of the final tubing samples of (a) sintered Polyflon™ F-201 tubing with no Agion®, (b) sintered Polyflon™ F-201/0.3% Agion® tubing, and (c) sintered Polyflon™ F-201/0.5% Agion® tubing obtained in Example 3.

FIG. 4 includes electron micrographs of a zeolite sample A with sonication of Experiment A taken at magnifications of (a) 100×, (b) 300×, and (c) 1000×.

FIG. 5 includes electron micrographs of a zeolite sample B without sonication of Experiment A taken at magnifications of (a) 100×, (b) 300×, and (c) 1000×.

FIG. 6 is a photograph of the final ribbon samples of (a) sintered Polyflon™ F-201 ribbon with no Agion®, (b) sintered Polyflon™ F-201/0.3% Agion® ribbon, and (c) sintered Polyflon™ F-201/0.5% Agion® ribbon obtained in Example 6.

FIG. 7 is a photograph of the final film samples of (a) sintered Polyflon™ M-17 with no Agion®, (b) sintered Polyflon™ M-17/0.01% Agion®, and (c) sintered Polyflon™ M-17/0.03% Agion® obtained in Example 7.

### DESCRIPTION OF EMBODIMENTS

The disclosure is described in detail below.

Fluoropolymers themselves, including PTFE, have no capability of killing microorganisms or inhibiting their growth. Therefore, under certain conditions, articles made by fluoropolymers such as PTFE can be contaminated with microbes, which is not desirable for their commonly intended uses. However, by introducing zeolite supporting a metal into the base PTFE resin, the resulting product and the articles made from it will gain the capability of killing bacteria or slowing down or stalling bacterial growth.

The disclosure relates to a composition containing polytetrafluoroethylene (PTFE) and zeolite supporting a metal (hereinafter, also referred to as a composition (1)).

Owing to the above features, the composition (1) has excellent antimicrobial performance. Since the metal is supported by zeolite, the antimicrobial performance can be maintained for a long time.

The composition (1) also has an excellently less colored appearance.

The PTFE may be either a homopolymer of tetrafluoroethylene (TFE) or a copolymer of TFE and a modifying monomer (hereinafter, referred to as a “modified PTFE”).

Examples of the modifying monomer include perhaloolefins such as HFP and CTFE; fluoro(alkyl vinyl ethers) containing a C1-05, particularly C1-C3 alkyl group; fluorinated cyclic monomers such as fluorodioxole; perhaloalkyl ethylenes; and ω-hydroperhaloolefins.

The modifying monomer content in the modified PTFE is typically within the range of 0.001 to 2.0 mass %. The lower limit of the modifying monomer content is more preferably 0.01 mass %, still more preferably 0.05 mass %. The upper limit of the modifying monomer content is more preferably 1.0 mass %, still more preferably 0.5 mass %, particularly preferably 0.3 mass %.

The PTFE is preferably a high-molecular-weight PTFE. The high-molecular-weight PTFE as used herein means a PTFE having non-melt-processability and fibrillation ability.

The non-melt-processability means a feature of a polymer that the melt flow rate thereof cannot be measured at a temperature higher than the crystal melting point in conformity with ASTM D1238 and D2116.

The presence or absence of the fibrillation ability can be determined by “paste extrusion”, a representative method of molding a “high-molecular-weight PTFE powder” which is a powder (fine powder) of a TFE emulsion polymer. The ability of a high-molecular-weight PTFE powder to be paste-extruded is due to the fibrillation ability thereof. If a non-sintered molded article obtained by paste extrusion shows substantially no strength or elongation (for example, if it shows an elongation of 0% and is broken when stretched), it can be considered as non-fibrillatable.

The PTFE preferably has a standard specific gravity (SSG) of 2.130 to 2.280. The standard specific gravity is determined by the water replacement method in conformity with ASTM D792 using a sample prepared in conformity with ASTM D4895. The “high molecular weight” as used herein means that the standard specific gravity is within the above range.

The PTFE preferably has a peak temperature of 333° C. to 347° C., more preferably 335° C. to 345° C. The peak temperature is the temperature corresponding to the maximum value on a heat-of-fusion curve with a temperature-increasing rate of 10° C./min using a differential scanning calorimeter (DSC) for a PTFE which has never been heated up to 300° C. or higher.

Preferably, the PTFE has at least one endothermic peak in a temperature range of 333° C. to 347° C. on a heat-of-fusion curve with a temperature-increasing rate of 10° C./min using a differential scanning calorimeter (DSC) for a PTFE which has never been heated up to 300° C. or higher, and has an enthalpy of fusion of 62 mJ/mg or higher at 290° C. to 350° C. calculated from the heat-of-fusion curve.

The PTFE is preferably in the form of particles having an average particle size of 100 to 1000 μm. The average particle size is more preferably 300 μm or greater and 700 μm or smaller.

The average particle size is determined in conformity with ASTM D4895.

The PTFE may be in the form of powder. When the PTFE is in the form of powder, it may be in the form of a PTFE fine powder or may be a PTFE molding powder. A PTFE fine powder is preferred.

The PTFE fine powder is a powder (secondary particles) obtainable by emulsion polymerizing TFE to form a PTFE aqueous dispersion, and then coagulating PTFE primary particles in the PTFE aqueous dispersion. The PTFE molding powder is a powder obtainable by suspension polymerizing TFE. The PTFE fine powder and the PTFE molding powder each may be obtainable by granulating the particles obtained by polymerization by a known method.

When the PTFE is in the form of powder, the average particle size (average secondary particle size) is preferably 100 to 1000 μm. The average particle size is more preferably 300 μm or greater and 700 μm or smaller.

The average particle size is determined in conformity with ASTM D4895.

The metal in the zeolite supporting a metal may be a metal having antimicrobial performance. For example, the metal may be at least one selected from the group consisting of copper, zinc, and silver, and is preferably silver.

The metal may be supported in the form of metal ions.

The proportion of the metal (metal ions) supported by the zeolite is preferably 1 to 30 mass %, more preferably 25 mass % or less, while more preferably 4 mass % or more, relative to the zeolite supporting a metal.

The zeolite is preferably in the form of particles having an average particle size of smaller than 10 μm. The zeolite having an average particle size within the above range allows the composition (1) to exert excellent antimicrobial performance even when the proportion of the zeolite in the composition (1) is relatively small. In addition, such zeolite has a lower coloring capability.

The average particle size is more preferably 6 μm or smaller, still more preferably 5 μm or smaller. The average particle size is also preferably 1 μm or greater.

The average particle size of the zeolite is the value corresponding to 50% of the cumulative volume in the particle size distribution determined using a laser diffraction particle size distribution analyzer (Jeol Ltd.) at a pressure of 0.1 MPa and a measurement time of 3 seconds without cascade impaction.

The zeolite is preferably substantially free from particles (agglomerates) having a particle size of 10 μm or greater.

The zeolite is very likely to agglomerate to form agglomerates (agglomerated powder) having a particle size of 10 μm or greater. Still, in order to exert excellent antimicrobial performance, the zeolite is preferably free from agglomerates having a particle size of 10 μm or greater.

The zeolite substantially free from particles having a particle size of 10 μm or greater can exert excellent antimicrobial performance even in a relatively small amount in the composition (1). Further, such zeolite can have a much lower coloring capability.

The presence or absence of particles having a particle size of 10 μm or greater can be determined by observation of the zeolite using a scanning electron microscope (SEM).

In the composition (1), the zeolite is preferably present in a proportion of 0.001 mass % or more, more preferably 0.01 mass % or more, still more preferably 0.1 mass % or more, relative to the total amount of the PTFE and the zeolite.

The proportion of the zeolite is preferably 5 mass % or less, more preferably 1 mass % or less, still more preferably less than 1 mass %, particularly preferably 0.5 mass % or less, relative to the total amount of the PTFE and the zeolite.

The composition (1) can exert excellent antimicrobial performance even when the proportion of the zeolite is relatively small as described above. Also, such a relatively small proportion of the zeolite can further reduce coloring.

The composition (1) may further contain an organic solvent.

In order to favorably use the composition (1) in extrusion molding, the organic solvent is preferably an extrusion aid for PTFE. The extrusion aid for PTFE is an extrusion aid that can be used in PTFE paste extrusion. Examples thereof include hydrocarbon solvents, fluorine solvents, and silicone solvents, and hydrocarbon solvents are preferred.

It is one preferred embodiment of the composition (1) that the organic solvent is a hydrocarbon solvent.

The hydrocarbon solvent may be any hydrocarbon usually used as an extrusion aid, for example. Specific examples thereof include solvent naphtha, white oil, naphthenic hydrocarbons, isoparaffinic hydrocarbons, and halides and cyanides of isoparaffinic hydrocarbons.

The naphthenic hydrocarbons and isoparaffinic hydrocarbons each preferably have a carbon number of 20 or lower, more preferably lower than 20.

The naphthenic hydrocarbons and isoparaffinic hydrocarbons each may be in the form of a halide or cyanide.

The hydrocarbon solvent is particularly preferably at least one selected from the group consisting of naphthenic hydrocarbons and isoparaffinic hydrocarbons. Specific examples thereof include Exxsol DSP80/100, Exxsol D30, Exxsol D40, Exxsol D60, Exxsol D80, Exxsol D95, Exxsol D110, Exxsol D130, Isopar G, Isopar E, Isopar H, Isopar K, and Isopar M (Exxon Mobil Corp.), and IP SOLVENT 1620 and IP SOLVENT 2028 (Idemitsu Kosan Co., Ltd.).

When the composition (1) contains the organic solvent, the amount of the organic solvent is preferably 10 to 30 mass % relative to the PTFE. The amount thereof is more preferably 15 mass % or more, while more preferably 20 mass % or less.

The composition (1) may further contain, as additional components, any appropriate fillers and additives such as carbon black, carbon fiber, graphite, carbon nanotube, glass, bronze, stainless steel, molybdenum disulfide, and polyimide, as appropriate.

The composition (1) may be produced by mixing the PTFE and the zeolite, optionally together with the organic solvent and/or the additional components, as appropriate. In order to provide a composition having much better antimicrobial performance and a much less colored appearance, the composition (1) is preferably produced by the production method to be described later in the disclosure. In the case of producing the composition (1) containing the organic solvent, the composition (1) is preferably produced by a production method including the steps (1-1) and (1-2) to be described later.

The composition (1) may be a molding composition. The molding composition can provide a molded article having excellent antimicrobial performance and a less colored appearance.

The disclosure also relates to a composition containing an organic solvent and zeolite supporting a metal (hereinafter, also referred to as a composition (2)).

Owing to the above features, the composition (2) can suitably be used for production (preferably, production by paste extrusion) of a polymer composition having excellent antimicrobial performance and an excellently less colored appearance, in particular a PTFE composition such as the aforementioned composition (1).

The composition (2) preferably contains no PTFE, and more preferably contains no fluororesin.

Examples of the organic solvent include the same organic solvents as those to be used for the composition (1). In particular, in order to suitably use the composition (2) in production of a PTFE composition, the organic solvent is preferably an extrusion aid for PTFE, more preferably a hydrocarbon solvent.

It is one preferred embodiment of the composition (2) that the organic solvent is a hydrocarbon solvent.

Examples of the zeolite supporting a metal in the composition (2) include the same zeolites as those to be used for the composition (1), and zeolite supporting silver is preferred.

In the composition (2), the zeolite may be dispersed in the organic solvent.

In the composition (2), the amount of the zeolite is preferably 0.004 to 25.0 mass % relative to the organic solvent.

The amount thereof is more preferably 20.0 mass % or less, still more preferably 16.7 mass % or less, relative to the organic solvent. The amount thereof is also more preferably 0.04 mass % or more, still more preferably 0.4 mass % or more, relative to the organic solvent.

The composition (2) may be produced by mixing the organic solvent and the zeolite. The mixing is preferably performed under ultrasonic irradiation. In this case, the zeolite in the organic solvent can have a fine particle size (e.g., can be substantially free from particles having a particle size of 10 μm or greater), and can lead to a composition having much better antimicrobial performance and a much less colored appearance when used in production of a composition of a polymer such as PTFE.

The ultrasonic irradiation may be performed by a usual method, and may be performed by, for example, applying ultrasonic waves at a frequency of 20 to 100 kHz for 1 to 10 minutes.

The disclosure also relates to a method for producing a composition including the steps of: (1) mixing an extrusion aid, zeolite supporting a metal, and polytetrafluoroethylene to prepare a mixture (1); (2) extruding the mixture (1) to prepare a mixture (2); and (3) removing the extrusion aid from the mixture (2) to provide a composition containing the polytetrafluoroethylene and the zeolite supporting a metal.

Owing to the above features, the production method of the disclosure can provide a composition having excellent antimicrobial performance. In addition, the production method can provide a composition capable of maintaining the antimicrobial performance for a long time.

The production method of the disclosure can also provide a composition having an excellently less colored appearance.

In the step (1), the extrusion aid, the zeolite, and the PTFE are mixed to prepare the mixture (1).

Examples of the extrusion aid include the same extrusion aids for PTFE as those to be used for the compositions (1) and (2), and the hydrocarbon solvents are preferred.

Examples of the zeolite include the same zeolites as those to be used for the compositions (1) and (2), and zeolite supporting silver is preferred.

Examples of the PTFE include the same PTFEs as those to be used for the composition (1), and a PTFE fine powder is preferred.

The mixing in the step (1) may be performed by (i) mixing the extrusion aid and the zeolite, and then mixing this mixture and the PTFE, (ii) mixing the zeolite and the PTFE, and then mixing this mixture and the extrusion aid, or (iii) mixing the extrusion aid and the PTFE, and then mixing this mixture and the zeolite. Preferred is the method (i) because this method can more uniformly mix the zeolite and the PTFE.

It is one preferred embodiment of the disclosure that the step (1) includes the steps of: (1-1) mixing the extrusion aid and the zeolite supporting a metal to prepare a mixture (1-1); and (1-2) mixing the mixture (1-1) and the polytetrafluoroethylene to prepare the mixture (1).

This embodiment can provide a composition having much better antimicrobial performance and a much less colored appearance.

The mixing in the step (1-1) is preferably performed under ultrasonic irradiation. In this case, the zeolite in the extrusion aid can have a fine particle size (e.g., can be substantially free from particles having a particle size of 10 μm or greater), and can lead to production of a composition having much better antimicrobial performance and a much less colored appearance in the step (3). The ultrasonic irradiation may be performed so as to disintegrate the zeolite.

The ultrasonic irradiation may be performed by a usual method, and may be performed by, for example, applying ultrasonic waves at a frequency of 20 to 100 kHz for 1 to 10 minutes.

The mixing in the step (1-1) may be performed so as to disperse the zeolite in the extrusion aid.

The mixing in the step (1-2) may be performed in conformity with a conventionally known method for mixing an extrusion aid and PTFE. The PTFE and the mixture (1-1) may be aged after the mixing, as appropriate, to blend well with each other.

The step (1-2) is a step performed after the step (1-1).

The step (1) may also be performed by adding zeolite supporting a metal to an aqueous dispersion of PTFE particles, co-coagulating the PTFE particles and the zeolite, dehydrating and drying the coagulum to provide a mixture, and then mixing an extrusion aid to the mixture. The co-coagulation may be performed under conventional conditions.

In the mixture (1-1) obtained in the step (1), the zeolite is preferably present in a proportion of 0.001 mass % or more, more preferably 0.01 mass % or more, still more preferably 0.1 mass % or more, relative to the total amount of the PTFE and the zeolite.

The proportion of the zeolite is preferably 5 mass % or less, more preferably 1 mass % or less, still more preferably less than 1 mass %, particularly preferably 0.5 mass % or less, relative to the total amount of the PTFE and the zeolite.

Even a relatively small proportion of the zeolite as described above can lead to a composition exerting excellent antimicrobial performance. Also, such a relatively small proportion of the zeolite can lead to a composition having a much less colored appearance.

In the step (1), any additional components may be mixed, as appropriate. Examples of the additional components include the same components as those to be used for the composition (1).

In the step (2), the mixture (1) is extruded to prepare a mixture (2). The step (2) is a step performed after the step (1).

The extrusion is preferably paste extrusion. The paste extrusion can be performed by filling the mixture (1) into a paste extruder and extruding the mixture (1) through the paste extruder, for example. The paste extruder and the extruding conditions may be conventional known ones.

The production method of the disclosure may further include a step of preforming the mixture (1) to provide a preformed article after the step (1) and before the step (2). The resulting preformed article can be used as the mixture (1) in the step (2).

The preforming may be performed by a common method. For example, the preforming may be performed by filling the mixture (1) into a mold, and then compressing the mixture. After a single compressing operation, the mixture (1) may be again filled into the mold and the process may be repeated (this process is referred to as addition molding).

The mold may be any mold having the shape of a desired preformed article or a similar shape and resistant to the molding pressure. It may be a cylindrical one called a cylinder, and may be a cylinder of a ram extrusion molding device or an extrusion cylinder of a paste extrusion molding device.

In the step (3), the extrusion aid is removed from the mixture (2) to provide a composition containing the PTFE and the zeolite.

The removal may be performed by heat-drying the mixture (2), for example. The heat-drying temperature may be any temperature that allows the extrusion aid to volatilize or decompose, and may be 150° C. to 250° C., for example.

The step (3) may be followed by expansion or sintering, as appropriate. The expansion and sintering conditions may be conventionally known conditions.

In the production method of the disclosure, a composition having excellent antimicrobial performance and an excellently less colored appearance is obtained after the step (3). The composition (hereinafter, also referred to as a composition (3)) obtained by the production method of the disclosure is also one aspect of the disclosure.

The above compositions (1) and (3) each may be formed into a molded article. The compositions (1) and (3) each may directly be used as a molded article, or may be molded or processed by a usual method, as appropriate.

The molded article is also one aspect of the disclosure.

The molded article may be in any form such as, but not limited to, a sheet, film, rod, pipe, fiber, or the like.

The molded article is preferably in the form of a tube, film, porous film, or the like.

The molded article can suitably be applied to various uses requiring antimicrobial performance and a less colored appearance, such as medical devices, packaging materials, filters, apparel, and footwear.

The disclosure also relates to antimicrobial polytetrafluoroethylene. By introducing antimicrobial agents, such as Agion®, into the base PTFE resin, the resulting product and the articles made from it will gain the capability of killing bacteria or slowing down or stalling bacterial growth. Agion® products contain elemental ions of silver, copper, zinc, or a combination of these elements as active antimicrobial ingredients in zeolite carriers.

In the disclosure, PTFE and an antimicrobial agent such as Agion® may be mixed in a weight ratio of between 95:5 and 99.999:0.001, more preferably between 99:1 and 99.99:0.01, and most preferably between 99.5:0.5 and 99.9:0.1. When the Agion® content is lower than 0.001 weight % relative to the PTFE, the antimicrobial effect may be too weak, which may result in too low a bacterial reduction. When the Agion® content is higher than 5 weight % relative to the PTFE, dispersion of Agion® in the PTFE composition may become poor, which may result in poor appearance, poor clarity, and/or a low mechanical strength of the final product.

The form of PTFE that may be used in the disclosure includes fine powders (typically, but not necessarily, produced from emulsion polymerization) and molding powders (typically, but not necessarily, produced from suspension polymerization). The PTFE that may be used in the disclosure further includes homopolymers and modified polymers. For example, Polyflon™ F-107 is a homopolymer fine powder, Polyflon™ F-201 is a modified fine powder, and Polyflon™ M-17 is a homopolymer molding powder. “PTFE homopolymer” means a polymer of tetrafluoroethylene (“TFE”) alone as obtained by polymerizing TFE alone, and hence it does not contain any other comonomer. “Modified PTFE” means a polymer of TFE and a small proportion of other comonomers. The proportion of the other comonomers is typically no more than 1 weight % relative to the total amount of the monomers including TFE.

As used in this specification, “PTFE” includes PTFE fine powder homopolymer, PTFE molding powder homopolymer, modified PTFE fine powder, modified PTFE molding powder, and dried PTFE aqueous dispersions.

The method of mixing PTFE and an antimicrobial agent includes dry mixing method (i.e., mixing antimicrobial agent dry powder with PTFE dry powder) and wet mixing method (i.e., dispersing antimicrobial agent dry powder in a liquid medium, such as a hydrocarbon isoparaffin (for example, Isopar™ fluid), which is used as a processing aid in PTFE paste extrusion, and then adding the mixture to PTFE dry powder for further mixing). In the wet mixing method, it is also possible to disperse PTFE dry powder in the liquid medium first, and then add the mixture to antimicrobial agent dry powder for further mixing.

The mixing can be conducted at a temperature, for example, between 0° C. and 50° C. Mixing PTFE with fillers and additives in the PTFE/isoparaffin mixing process is a common way of adding a filler/additive into PTFE. For PTFE molding powder, the filler/additive is usually mixed with PTFE dry powder directly. For PTFE fine powder: the filler/additive can be mixed with PTFE dry powder first, followed by the addition of isoparaffin into the mixture; or the filler/additive can be mixed with isoparaffin first, and then mixed with PTFE fine powder. Isopar™ refers to synthetic isoparaffins that are manufactured by Exxon Mobile Chemical. In particular, Isopar™ M and Isopar™ E that appear in the Examples later on refer, respectively, to Isopar™ M Fluid and Isopar™ E Fluid.

Examples of other fillers and/or additives that may be incorporated into the PTFE compositions of the disclosure include carbon black, carbon fiber, graphite, carbon nanotubes, glass, bronze, stainless steel, molybdenum disulfide, polyimide, etc.

Some of the advantages that may be achieved by the disclosure include: high antimicrobial efficiency (namely, a very low antimicrobial agent dosage into PTFE can result in a high bacteria reduction); easy processing (namely, dry or wet mixing is used to incorporate an antimicrobial agent into PTFE, and no special technology is needed); and no or low color change (namely, the addition of an antimicrobial agent, especially Agion® AK80H, does not change or changes only insignificantly the color of unsintered and sintered PTFE products). “Sintered PTFE” refers to a PTFE product (for example, tubing, tape, film, etc.) that has been treated at above its melting temperature (usually at above 350° C.). The advantage regarding no or low color change is achieved by using a mixing method that disperses and distributes Agion® well in the PTFE composition, thereby reducing or eliminating Agion® powder agglomerates that can cause white spots in the final product. Agion® itself does not change color at high temperatures.

Accordingly, the disclosure also relates to the following (1) to (24).

(1) A composition comprising:
a polytetrafluoroethylene; and
an antimicrobial agent;
   wherein the polytetrafluoroethylene and the antimicrobial agent are in a compression-molded state.

(2) A composition comprising:
a polytetrafluoroethylene; and
an antimicrobial agent;
   wherein the polytetrafluoroethylene and the antimicrobial agent are in an extruded state.

(3) The composition according to any one of (1) and (2), wherein the polytetrafluoroethylene is selected from the group consisting of a polytetrafluoroethylene homopolymer, a modified polytetrafluoroethylene, and a mixture of a polytetrafluoroethylene homopolymer and a modified polytetrafluoroethylene.

(4) The composition according to any one of (1)-(3), wherein the polytetrafluoroethylene is in the form of fine powders.

(5) The composition according to any one of (1)-(3), wherein the polytetrafluoroethylene is in the form of molding powders.

(6) The composition according to any one of (1)-(3), wherein the polytetrafluoroethylene is in the form of dried aqueous dispersions.

(7) The composition according to any one of (1)-(6), wherein the antimicrobial agent comprises elemental ions selected from the group consisting of silver ions, copper ions, and zinc ions.

(8) The composition according to any one of (1)-(6), wherein the antimicrobial agent comprises silver ions and zinc ions.

(9) The composition according to any one of (1)-(8), wherein the antimicrobial agent comprises zeolites.

(10) The composition according to any one of (1)-(9), wherein the weight ratio of the polytetrafluoroethylene to the antimicrobial agent is between 95:5 and 99.999:0.001.

(11) The composition according to any one of (1)-(9), wherein the weight ratio of the polytetrafluoroethylene to the antimicrobial agent is between 99:1 and 99.99:0.01.

(12) The composition according to any one of (1)-(9), wherein the weight ratio of the polytetrafluoroethylene to the antimicrobial agent is between 99.5:0.5 and 99.9:0.1

(13) A method for making the composition of any one of (1) and (3)-(12), the method comprising the steps of:
mixing dry powder of the polytetrafluoroethylene and dry powder of the antimicrobial agent to prepare a mixture; and
compression-molding the mixture.

(14) A method for making the composition of any one of (2)-(12), the method comprising the steps of:
mixing dry powder of the polytetrafluoroethylene and dry powder of the antimicrobial agent to prepare a first mixture;
adding a liquid medium to the first mixture to prepare a second mixture;
mixing the second mixture; and
extruding the second mixture.

(15) A method for making the composition of any one of claims 2-12, the method comprising the steps of:
dispersing dry powder of the antimicrobial agent in a liquid medium to prepare a first mixture;
adding the first mixture to dry powder of the polytetrafluoroethylene to prepare a second mixture;
mixing the second mixture; and
extruding the second mixture.

(16) A method for making the composition of any one of (2)-(12), the method comprising the steps of:
dispersing dry powder of the polytetrafluoroethylene in a liquid medium to prepare a first mixture;
adding the first mixture to dry powder of the antimicrobial agent to prepare a second mixture;
mixing the second mixture; and
extruding the second mixture.

(17) The method according to any one of (14)-(16), wherein the liquid medium is a paste-extrusion processing aid.

(18) The method according to (17), wherein the paste-extrusion processing aid is a hydrocarbon isoparaffin.

(19) A tube comprising the composition according to any one of (1)-(12).

(20) A medical device comprising the tube according to (19).

(21) A medical device comprising a component, wherein the component comprises the composition according to any one of (1)-(12).

(22) A packaging article comprising a film, wherein the film comprises the composition according to any one of (1)-(12).

(23) A water or air filter comprising a porous membrane, wherein the porous membrane comprises the composition according to any one of (1)-(12).

(24) An apparel or footwear comprising a porous or solid membrane, wherein the porous or solid membrane comprises the composition according to any one of (1)-(12).

### EXAMPLES

The detailed description that follows generally describes various exemplary embodiments of the disclosure, and should not be considered to be exclusive of other equally effective embodiments, as would be understood by those of ordinary skill in the art. Further, numerous specific details are given in order to provide a thorough understanding of the embodiments and other examples. In some instances, however, well-known methods, procedures, and components have not been described in detail, so as to not obscure the following description. The embodiments and examples disclosed are for exemplary purposes only. Other embodiments and examples may be employed in lieu of, or in combination with, the embodiments and examples disclosed. In what follows, unless otherwise specified, the amounts of the components in a composition are all expressed in weight % relative to the total amount of the composition. Also, where a numerical range is provided, it is understood that all numerical subsets of that range, and all the individual integers contained therein, are provided as part of the disclosure.

Studies were carried out to investigate the antimicrobial capabilities of the PTFE/antibacterial agent (such as Agion® AK80H from Sciessent) compositions of the disclosure. Agion® AK80H contains 4-6% by weight of silver and 13% by weight of zinc in a zeolite carrier.

### Example 1

Three different levels of Agion® AK80H (with a content of 0.3 wt %, 1 wt %, and 3 wt %, respectively, relative to the total composition) were dry-mixed with PTFE Polyflon™ F-107, and then compression-molded disk samples were made for antimicrobial performance tests against S. aureus (ATCC# 6538), following the Modified ASTM-E2180 standard. The compression-molded disk samples that were tested had a diameter of 70 mm and a thickness of 2 mm. The initial inoculum for these tests was at a 10⁶ concentration, which is consistent with what is used for medical testing. (For non-medical testing, the concentration of the initial inoculum would be 10⁵.) All three unsintered samples tested and all three sintered samples tested showed 99.999% organism reduction. PTFE Polyflon™ F-107 (manufactured by Daikin America, Inc.) is a high-molecular-weight polytetrafluoroethylene fine powder resin for paste extrusion. F-107 has been specifically designed for the manufacture of unsintered tapes, sintered tapes, and porous applications at low reduction ratios.

More specifically as to the dry-mixing process for the F-107 disk samples, 100 g of F-107 powder was mixed with 0.3 g, 1 g, and 3 g of Agion® AK80H powder, respectively, in a sealed plastic jar at room temperature. For large volume manufacturing, equipment such as a V-type mixer machine can be used for mixing.

For the sample preparation process of unsintered F-107 disk samples, the following steps were taken.

Condition sample at 25.00.

Weigh out a sample of F-107/Agion® at 14.5 g.

Select the 76 mm die.

Mold fine powder samples at 14,074 lbs. of force.

Remove the sample and allow to age for at least 1 hour.

For the sample preparation process of sintered F-107 disk samples, the following steps were taken.

Condition sample at 25.00.

Weigh out a sample of F-107/Agion® at 14.5 g.

Select the 76 mm die.

Mold fine powder samples at 14,074 lbs. of force.

Remove the sample and allow to age for at least 1 hour.

Sinter the disk at 380 C for 30 minutes.

Allow sample disks to cool and condition in temperature controlled area at 250 C.

Table 1 below shows the results obtained from the antimicrobial studies of unsintered compression-molded disk samples of the PTFE compositions, and Table 2 shows the results obtained for sintered compression-molded disk samples of the PTFE compositions.

TABLE 1
Unsintered Polyflon ™ F-107/Agion ® Disk Samples.

| Agion ® | Bacteria |
|---|---|
| Content | Reduction |
| (wt %) | (%) |
| 0 | 0 |
| 0.3 | 99.999 |
| 1 | 99.999 |
| 3 | 99.999 |

TABLE 2
Sintered Polyflon ™ F-107/Agion ® Disk Samples.

| Agion ® | Bacteria |
|---|---|
| Content | Reduction |
| (wt %) | (%) |
| 0 | 0 |
| 0.3 | 99.999 |
| 1 | 99.999 |
| 3 | 99.999 |

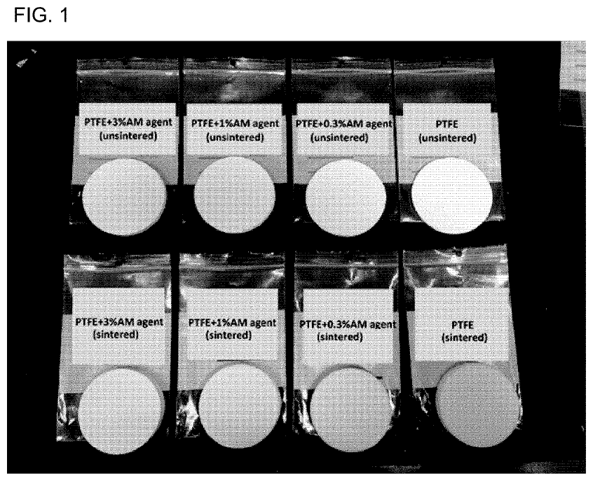

A photograph of the compression-molded disk samples of the PTFE compositions that were tested are shown in FIG. 1. The term “AM agent” appearing on the labels in the photograph refers to Agion® AK80H. The photograph shows the shape of the unsintered and sintered disk samples as well as the white color of the samples that did not change after sintering. (The effects of the shadow are an artefact.)

### Example 2

Three different levels of Agion® AK80H (with a content of 0.01 wt %, 0.1 wt %, and 0.5 wt %, respectively, relative to the total composition) were first mixed with Isopar™ M, and then Agion®/Isopar™ M was mixed with PTFE Polyflon™ F-107. The Polyflon™ F-107 : Isopar™ M ratio was 100:24.2 by weight for all the samples. The mixture was compression-molded into a preform, and then the preform was extruded into a strand. The strand was compression-molded into a tape, and then the tape was dried in an oven at 250° C. for 30 minutes to eliminate Isopar™ M. The extruded strands had a diameter of around 6 mm, and the dried tape samples that were tested had a length of around 70 mm, a width of around 30 mm, and a thickness of around 1 mm. The tape samples were subjected to antimicrobial performance tests against S. aureus (ATCC# 6538), following the Modified ASTM-E2180 standard. The F-107/0.5% Agion® tape sample showed 99.99% organism reduction.

Here, a strand was first made by paste extrusion to generate a fibrillated specimen, and then a tape was made by compressing the strand. This was done because conducting antimicrobial tests on flat samples such as tapes, rather than on strands, would generally lead to more reliable results.

TABLE 3
Unsintered Polyflon ™ F-107/Agion ® Tape Samples.

| | Agion ® | Bacteria |
|---|---|---|
| PTFE | Content | Reduction |
| Grade | (wt %) | (%) |
| F-107 | 0 | 0 |
| | 0.01 | 54 |
| | 0.1 | 96 |
| | 0.5 | 99.99 |

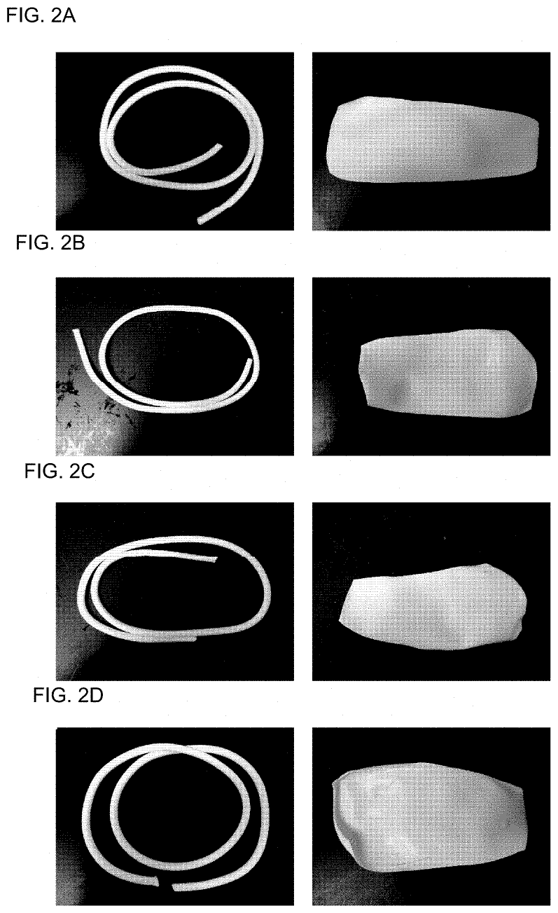

The photographs in FIG. 2 show the extruded strand (on the left) and the final tape sample (on the right) for the Agion® content indicated. They show the shapes of the extruded strands and of the compressed and dried tape samples. The photographs also show that the Agion® component does not affect the color even after processing. (The effects of the shadow are an artefact.)

### Example 3

Two different levels of Agion® AK80H (with a content of 0.3 wt % and 0.5 wt %, respectively, relative to the total composition) were first mixed with Isopar™ E, and then Agion®/Isopar™ E was mixed with PTFE Polyflon™ F-201. The Polyflon™ F-201 : Isopar™ E ratio was 100:22.5 by weight for all the samples. The mixture was compression-molded into a preform, and then the preform was extruded into a tubing. The tubing was sintered in an oven at 380° C. for 30 minutes. The sintered tubing samples that were tested had an outer diameter of 5 mm, an inner diameter of 4 mm, and a wall thickness of 0.5 mm. The tubing samples were subjected to antimicrobial performance tests against S. aureus (ATCC# 6538), following the Modified ASTM-E2180 standard. The F-201/0.5% Agion® tubing sample showed 99.99% organism reduction. Polyflon™ F-201 is a modified polytetrafluoroethylene fine powder resin for paste extrusion. F-201 has been designed for spaghetti tubing, thin wall tubing, and wire coating applications.

TABLE 4
Sintered Polyflon ™ F-201/Agion ® Tubing Samples.

| Agion ® | Bacteria |
|---|---|
| Content | Reduction |
| (wt %) | (%) |
| 0 | 0 |
| 0.3 | 35 |
| 0.5 | 99.99 |

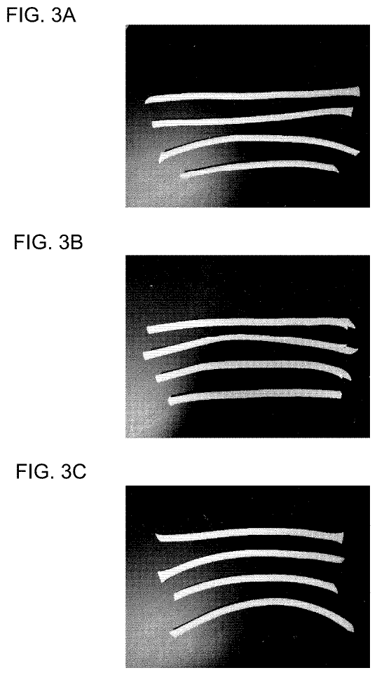

The photographs in FIG. 3 show the final tubing samples obtained for the Agion® content indicated. They show the shapes of the extruded and sintered tubing samples obtained. The photographs also show that the Agion® component does not affect the color even after processing. (The effects of the shadow are an artefact.)

### Example 4

The process of Example 3 was repeated, except that three different levels of Agion® AK80H (with a content of 0.1 wt %, 0.3 wt %, and 0.5 wt %, respectively, relative to the total composition) were used, and the Agion® AK80H Isopar™ E mixture was sonicated for 5 mins before mixed with Polyflon™ F-201. All three samples showed 99.99% organism reduction.

TABLE 5
Sintered Polyflon ™ F-201/Agion ® Tubing Samples.

| Agion ® | Bacteria |
|---|---|
| Content | Reduction |
| (wt %) | (%) |
| 0 | 0 |
| 0.1 | 99.99 |
| 0.3 | 99.99 |
| 0.5 | 99.99 |

### Example 5

The steps of Example 4 were repeated, except that Agion® AK80H was replaced by zeolite (Agion® AD85H-M) containing 20 to 24 mass % of silver ions in an amount shown in Table 6 below. The results are shown in Table 6 below.

TABLE 6
Sintered Polyflon ™ F-201/Agion ® Tubing Samples.

| Agion ® | Bacteria |
|---|---|
| Content | Reduction |
| (wt %) | (%) |
| 0 | 0 |
| 0.025 | 99.8 |
| 0.01 | 99.8 |
| 0.1 | 99.9 |

### Experiment A (Determination of the Presence of Zeolite Agglomerates)

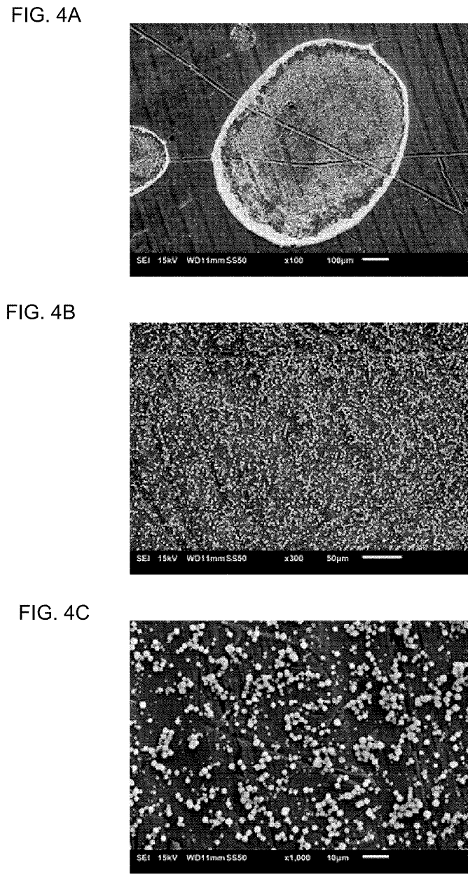

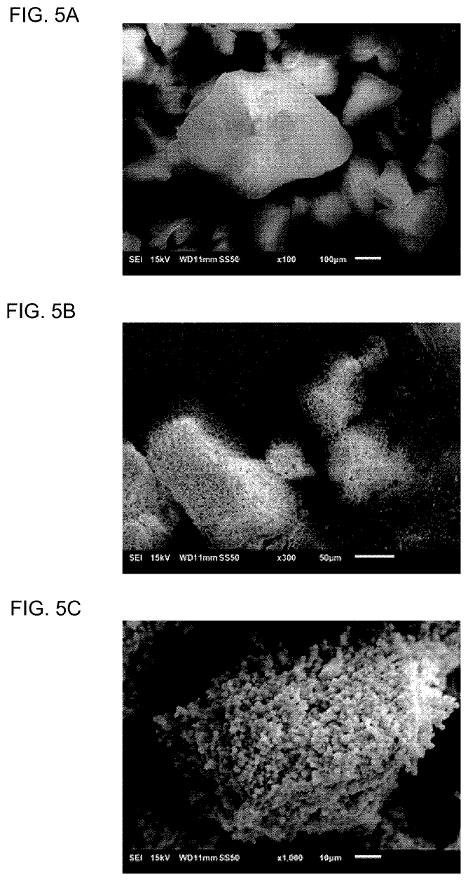

To the extrusion aid, Isopar E, was added 0.4 mass % of zeolite. The mixture was sonicated for five minutes and then completely dried at room temperature. Thereby, a sample A was obtained. Separately, a zeolite sample B without this treatment was prepared. Each of the zeolite samples A and B was fixed on a carbon double-sided tape and photographed using a scanning electron microscope (JSM-7600F, Jeol Ltd.) at an accelerating voltage of 15 kV and magnifications of 100×, 300×, and 1000×. The resulting electron micrographs are shown in FIG. 4 and FIG. 5.

These electron micrographs were analyzed using particle size distribution analysis software Mac-View ver. 4.0 to calculate the projected area diameters (Heywood diameters) of the zeolite agglomerates. These values were defined as the particle sizes of the agglomerates.

The sample B contained particles having a particle size of 40 μm. In contrast, the sample A contained only particles having a particle size of 4 μm or smaller.

The above results seem to demonstrate that the zeolites in the compositions obtained in Examples 4 and 5 are substantially free from particles having a particle size of 10 μm or greater.

### Example 6

Two different levels of Agion® AK80H (with a content of 0.3 wt % and 0.5 wt %, respectively, relative to the total composition) were first mixed with Isopar™ E, and then Agion®/Isopar™ E was mixed with PTFE Polyflon™ F-201. The Polyflon™ F-201 : Isopar™ E ratio was 100:23.5 by weight for all the samples. The mixture was compression-molded into a preform, and then the preform was extruded into a tubing. The tubing was compression-molded into a ribbon, and then the ribbon was sintered in an oven at 380° C. for 30 minutes. The sintered ribbon samples that were tested had a length of around 70 mm, a width of around 15 mm, and a thickness of around 0.3 mm. The ribbon samples were subjected to antimicrobial performance tests against S. aureus (ATCC# 6538), following the Modified ASTM-E2180 standard. The F-201/0.5% Agion® ribbon sample showed 99.98% organism reduction.

Here, a tubing was first made by paste extrusion to generate a fibrillated specimen, and then a ribbon was made by compressing the tubing. This was done because conducting antimicrobial tests on flat samples such as ribbons, rather than on tubings, would generally lead to more reliable results.

TABLE 7
Sintered Polyflon ™ F-201/Agion ® Ribbon Samples.

| Agion ® | Bacteria |
|---|---|
| Content | Reduction |
| (wt %) | (%) |
| 0 | 0 |
| 0.3 | 0 |
| 0.5 | 99.98 |

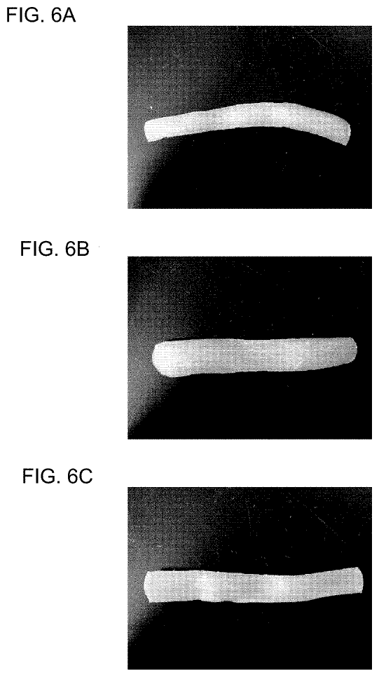

The photographs in FIG. 6 show the final ribbon samples obtained for the Agion® content indicated. They show the shapes of the sintered ribbon samples obtained.

### Example 7

Two different levels of Agion® AK80H (with a content of 0.01 wt % and 0.03 wt %, respectively, relative to the total composition) were dry-mixed with PTFE Polyflon™ M-17 (for example, for the 0.03 wt % Agion® sample, 199.94 g of Polyflon™ M-17 was mixed with 0.06 g of Agion®), and then the mixture was compression-molded into a column-shaped billet. The billet was sintered at 370° C. for more than 5 hours, and after cooling to 25° C., it was skived into 0.1 mm-thick films. The sintered film samples that were tested had a length of around 100 mm, a width of around 50 mm, and a thickness of 0.1 mm. The film samples were subjected to antimicrobial performance tests against S. aureus (ATCC# 6538), following the Modified ASTM-E2180 standard. The M-17/0.03% Agion® film sample showed 99.998% organism reduction. Polyflon™ M-17 is a polytetrafluoroethylene virgin granular fine cut resin. This general-purpose molding powder has been specifically designed for use in medium-to-large billet compression molding.

TABLE 8
Sintered Polyflon ™ M-17/Agion ® Film Samples.

| Agion ® | Bacteria |
|---|---|
| Content | Reduction |
| (wt %) | (%) |
| 0 | 0 |
| 0.01 | 0 |
| 0.03 | 99.998 |

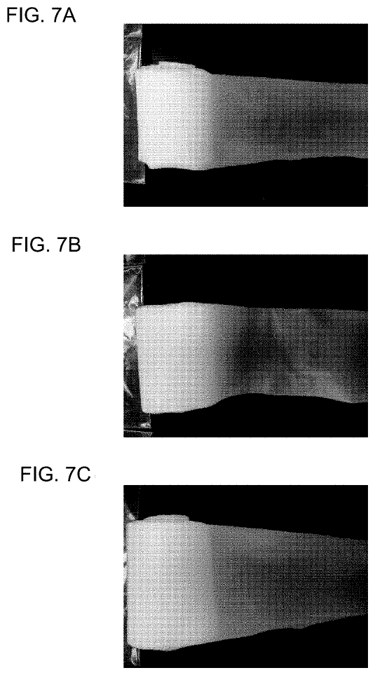

The photographs in FIG. 7 show the final film samples obtained for the Agion® content indicated. They show the shapes of the sintered film samples obtained and the extent of their transparency. The photographs also show that the color of the Agion® component does not affect the transparency of the PTFE film.

Now that exemplary embodiments of the disclosure have been shown and described in detail, various modifications and improvements thereon will become readily apparent to those skilled in the art.

It will be understood that one or more of the elements or exemplary embodiments described can be rearranged, separated, or combined without deviating from the scope of the disclosure. For ease of description, various elements are, at times, presented separately. This is merely for convenience and is in no way meant to be a limitation.

Further, it will be understood that one or more of the steps described can be rearranged, separated, or combined without deviating from the scope of the disclosure. For ease of description, steps are, at times, presented sequentially. This is merely for convenience and is in no way meant to be a limitation.

While the various elements, steps, and exemplary embodiments of the disclosure have been outlined above, it is evident that many alternatives, modifications, and variations will be apparent to those skilled in the art. The various elements, steps, and exemplary embodiments of the disclosure, as described above, are intended to be illustrative, not limiting. Various changes can be made without departing from the spirit and scope of the present disclosure. Accordingly, the spirit and scope of the present disclosure is to be construed broadly and not limited by the foregoing specification.

No element, act, or instruction used in the description of the disclosure should be construed as critical or essential unless explicitly described as such. Also, as used herein, the article “a” is intended to include one or more items. Where only one item is intended, the term “one,” “single,” or similar language is used.

### INDUSTRIAL APPLICABILITY

The disclosure has industrial applicability in that it provides, among other things, polytetrafluoroethylene compositions having antimicrobial capabilities and methods for making these compositions.

1. A composition comprising:
polytetrafluoroethylene; and
zeolite supporting a metal.

2. The composition according to claim 1,
wherein the polytetrafluoroethylene is in the form of particles having an average particle size of 100 to 1000 μm.

3. The composition according to claim 1,
wherein the zeolite is present in a proportion of 0.001 mass % or more and 5 mass % or less relative to the total amount of the polytetrafluoroethylene and the zeolite.

4. The composition according to claim 1, further comprising an organic solvent.

5. A composition comprising:
an organic solvent; and
zeolite supporting a metal.

6. The composition according to claim 4,
wherein the organic solvent is an extrusion aid for polytetrafluoroethylene.

7. The composition according to claim 4,
wherein the organic solvent is a hydrocarbon solvent.

8. The composition according to claim 1,
wherein the metal is at least one selected from the group consisting of copper, zinc, and silver.

9. The composition according to claim 1,
wherein the zeolite is in the form of particles having an average particle size of smaller than 10 μm.

10. The composition according to claim 9,
wherein the zeolite is substantially free from particles having a particle size of 10 μm or greater.

11. A method for producing a composition comprising the steps of:
(1) mixing an extrusion aid, zeolite supporting a metal, and polytetrafluoroethylene to prepare a mixture (1);
(2) extruding the mixture (1) to prepare a mixture (2); and
(3) removing the extrusion aid from the mixture (2) to provide a composition containing the polytetrafluoroethylene and the zeolite supporting a metal.

12. The production method according to claim 11,
wherein the step (1) includes the steps of:
(1-1) mixing the extrusion aid and the zeolite supporting a metal to prepare a mixture (1-1); and
(1-2) mixing the mixture (1-1) and the polytetrafluoroethylene to prepare the mixture (1).

13. The production method according to claim 12,
wherein the mixing in the step (1-1) is performed under ultrasonic irradiation.

14. A molded article comprising the composition according to claim 1.

15. The molded article according to claim 14,
wherein the molded article is in the form of a tube.

16. The molded article according to claim 14,
wherein the molded article is in the form of a film.

17. The molded article according to claim 14,
wherein the molded article is in the form of a porous film.

18. The composition according to claim 5,
wherein the organic solvent is an extrusion aid for polytetrafluoroethylene.

19. The composition according to claim 5,
wherein the organic solvent is a hydrocarbon solvent.

20. The composition according to claim 5,
wherein the metal is at least one selected from the group consisting of copper, zinc, and silver.

21. The composition according to claim 5,
wherein the zeolite is in the form of particles having an average particle size of smaller than 10 μm.

22. The composition according to claim 21,
wherein the zeolite is substantially free from particles having a particle size of 10 μm or greater.
